(19) United States
(12) Patent Application Publication
(10) Pub. No.: US 2004/0205933 A1
(43) Pub. Date: Oct. 21, 2004

(54) Modular pivotal hinge

(76) Inventors: Chung Nan Hsieh, Hsinchu (TW); Wen Chi Lin, Hsinchu (TW)

Correspondence Address: Ladas & Parry, 26 West 61st Street, New York, NY, 10023, US

(21) Appl. No.: 10/842,916

(22) Filed: May 6, 2004

(30) Foreign Application Priority Data
Dec. 26, 2003 (TW) 092222786
Apr. 2, 2003 (TW) 093205088

(51) Int. Cl. B60P 1/00

(52) U.S. Cl. 16/277

(57) ABSTRACT

The present invention discloses a modular pivotal hinge comprising a pivotal shaft, a rotating bracket, a base, elastic means, and a buffering means. The pivotal shaft comprises an axle. The rotating bracket comprises a mounting part for fixation to a second member, and a rotating part for coupling to the axle and allowing said rotating bracket to pivot around said axle. The base comprises a mounting part for fixation to the first member and a slot constructed in a way to allow the axle to be inserted and secured therein. The elastic means provides a spring force to urge the second member to pivot away from the first member. The buffering means comprises a head for contacting the axle and a buffer structure elastically biasing against the head toward the axle.

### BACKGROUND OF THE INVENTION

1. Filed of the Invention

The present invention relates to a modular pivotal hinge for use with a flip-up type electronic device such as a laptop computer. The present invention is particularly related to a modular pivotal hinge which is easy to produce and has improved yields and a longer serve life.

2. Description of the Related Art

U.S. Pat. No. 6,553,625 ('625 patent) discloses pivotal hinge 1 used with a flip-up type electronic device such as a laptop computer. The pivotal hinge 1 comprises a pivotal shaft 10, a rotating bracket 20, a first coil spring 30, a friction device, and a fastening member R. During assembly, the elements 10, 20, 30 and 40 are arranged on the shaft member 14 so as to obtain a pivotal hinge 1 and are then secured in place by the fastening member R.

Although the prior art pivotal hinge of the '625 patent can achieve its intended effects and overcome the defects of old pivotal hinges, it still bears the following disadvantages:

(1) During manufacturing, the pivotal shaft must be subjected to axial-forging and horizontal punching steps, which easily deflects the shape of the elongated body of the pivotal shaft. Accordingly, the products have a higher defect rate and the production is relatively time-consuming.

(2) The elongated body of the pivotal shaft is easily deflected.

(3) Stress concentration appears at the neck of the elongated pivotal shaft. Accordingly, the pivotal shaft is easily broken and the service life is short.

(4) The reduction of the radius of the pivotal shaft will shorten the service live. Accordingly, the whole pivotal hinge must be relatively larger.

(5) The mounting end and the shaft end are integrally formed. The rotation of the hinge will result in unexpected vibration.

(6) The spring retaining element fails to provide sufficient strength.

In view of the above defects, it is necessary to provide a modular pivotal hinge having the advantages of simplified structure, easy production, improved product yields, reduction of manufacturing time and longer service life.

### SUMMARY OF THE INVENTION

A modular pivotal hinge according to the present invention comprises a pivotal shaft, a rotating bracket, a base, elastic means, and a buffering means.

The pivotal shaft comprises an axle. The rotating bracket comprises a mounting part for fixation to a second member (LCD display), and a rotating part for coupling to the axle and allowing said rotating bracket to pivot around said axle. The base comprises a mounting part for fixation to a first member (machine) and a slot constructed in a way to allow the axle to be inserted and secured therein. The elastic means provides a spring force to urge the second member to pivot away from the first member. The buffering means is coupled to the rotating bracket, and elastically biases against the axle, which comprises a buffer structure elastically biasing against the head toward the axle.

The above and other features and advantages of the present invention may be realized from the accompanying drawings and the following descriptions.

### BRIEF DESCRIPTION OF THE DRAWINGS

FIG. 1 is an exploded perspective view of a first embodiment of the present invention;

FIGS. 2 and 3 are assembled perspective views of the embodiment of FIG. 1 using a tuning device and an outer cap;

FIG. 4 is an exploded view of a modified embodiment of FIG. 1 in which the sleeve and pivotal shaft head of FIG. 1 are removed;

FIG. 5 is an exploded perspective view of another embodiment of the present invention;

FIGS. 6 and 7 are assembled perspective views of the embodiment of FIG. 5;

FIGS. 8, 9A to 9C, 10A, and 10B illustrate a modified embodiment of the modular pivotal hinge 100 of FIGS. 5 to 7 using leakage-proof elements;

FIG. 11 is an exploded perspective view of a further embodiment of the present invention; and

FIGS. 12 and 13 are assembled perspective views of the embodiment of FIG. 11.

### DETAILED DESCRIPTION OF THE INVENTION

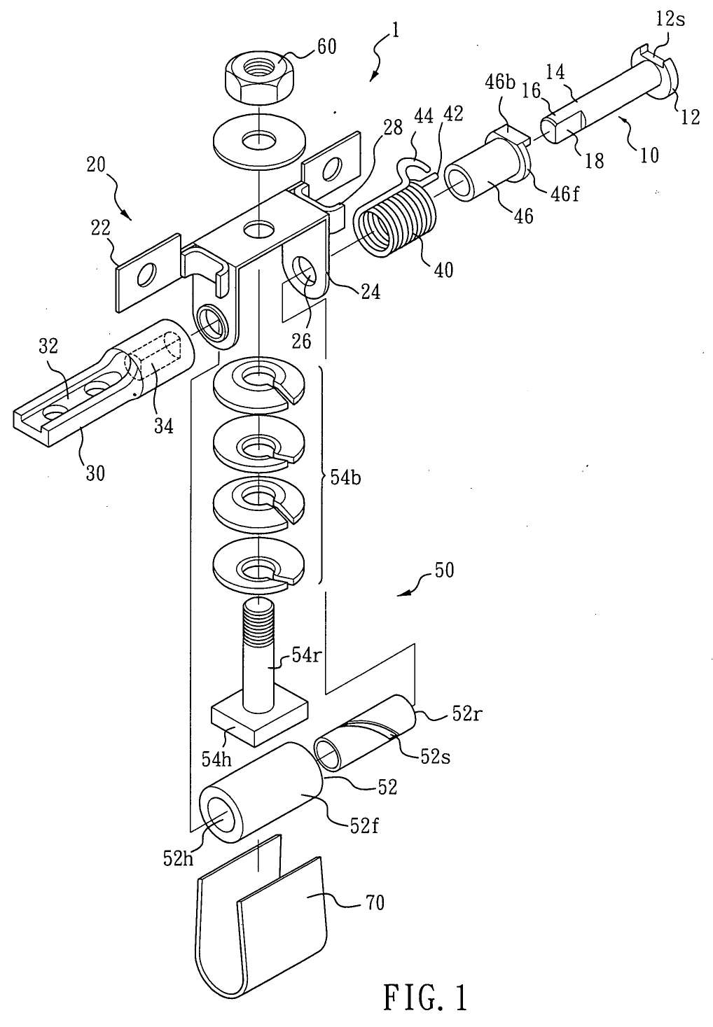

The present invention relates to a modular pivotal hinge hinged between a first member (such as a machine) and a second member (such as an LCD display) so as to allow said first and second members to pivot with respect to each other. As shown in FIG. 1, a first embodiment of a modular pivotal hinge 1 of the present invention comprises a pivotal hinge 10, a rotating bracket 20, a base 30, an elastic means 40, and a buffering means 50.

Pivotal shaft 10 preferably comprises a head 10, an axle 14 extending along a pivotal axis (not shown), and an inset 16. Head 12 preferably comprises a supporting surface 12s associated with elastic means 40. Inset 16 preferably comprises a stopping portion 18 associated with the base 30. The stopping portion may shape into a facet or facets such as that shown in FIG. 1, or other similar structures that can prevent the pivotal shaft 10 from rotating with respect to the base 30.

The rotating bracket 20 comprises a mounting part 22 and a rotating part 24. The mounting part 22 mounts the rotating bracket 20 to the second member. The rotating part 24 couples the rotating bracket 20 to the axle 14 and allows said rotating bracket to pivot around said axle 14. The rotating bracket 20 is preferably in a U-shape with a pair of legs which form a rotating part 24 provided with holes 26. The rotating part 24 is preferably provided with flanges which extend a thickness from each of the holes 26. The flanges are used to broaden the contact area of the rotating part 24 with the pivotal shaft 10, which helps to prolong the life of the pivotal hinge 1. The rotating bracket 20 is preferably provided with retaining elements 28 in association with elastic means 40.

Base 30 comprises a mounting part 32 for fixation to the first member and a slot 34 extending from an end thereof to the inside thereof along an axis. The base 30 is preferably formed by casting so as to provide the effect of shock absorption and minimize vibration. The slot 34 is constructed to allow the axle 14 to be inserted and fixed therein without rotation.

The elastic means 40 is used to provide a spring force which rotates the second member away from the first member. The elastic means 40 is preferably in the form of a coil spring or coil springs provided around the axle 14 extending outside, each of the coil springs having a first end 42 and a second end 44. The first end 42 is supported on the supporting surface 12s such that the coil spring or coil springs can bias against the first member due to the non-rotatable coupling between the pivotal shaft 10 and the base 30. The second end 44 is supported on the retaining element 28 so as to bias against the second member. A liner 46 preferably made of nylon or rubber can be arranged inside the coil spring-type elastic means 40 for purpose of preventing oil slick or providing lining protection. The liner 46 is shaped with a flange 46f which includes a pad 46b for lying on the supporting surface 12s such that it is clamped between the elastic means 40 and supporting surface 12s.

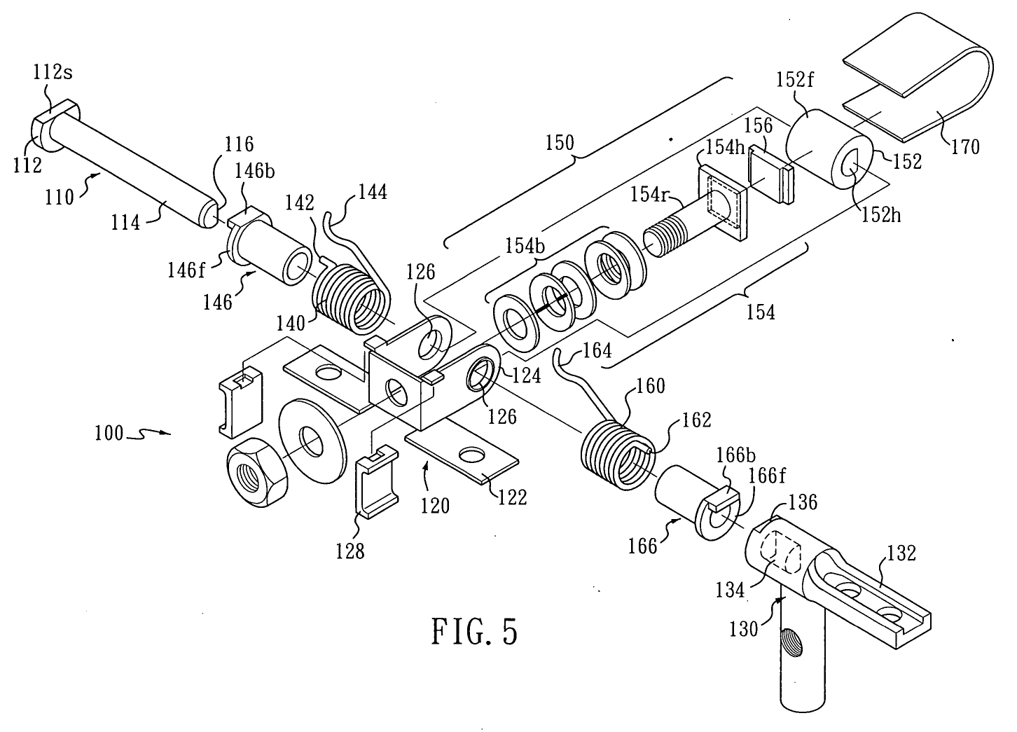

The buffering means comprises an optional sleeve 52, a post 54r, a head 54h in contact with the axle 14 (or sleeve 52 in case it is present), and a buffer structure 54b biasing against the head 54h. The sleeve 52 has a cylindrical surface 52f and a cylindrical through hole 52h through which the sleeve 52 can rotate with respect to the axle 14. An oil ring 52r provided with an oil slot 52s for storing lubricant can be arranged in the through hole 52h. According to a modified embodiment of the present invention, the surface 52f shapes as a cam sidewall having varying curvature and surrounding the rotary through hole 52h, and at the same time the through hole 52h is configured in a way that the sleeve 52 is non-rotatably coupled to the axle 14 (such as sleeve 152 shown in FIG. 5). This obtains the benefit that, when the head 54h is urged against the surface 52f by the buffer structure 54b, the friction between the head 54h and surface 52f would vary during the pivotal action of the pivotal hinge 1; wherein the part of the surface 52f having a greater curvature would bring a bigger friction. An oil-proof ring (not shown) for preventing leakage of oil slick can be provided between the head 54h and sleeve 52. Alternatively, a friction block with an arcuated edge (for contacting surface 52f) can be inserted between the head 54h and sleeve 52 to provide friction. If the friction block is not used, it is recommended that the head 54h should provide friction at the face opposing the surface 52f.

The post 54r substantially extends along a longitudinal axis supported by the rotating bracket 20, wherein the longitudinal axis is generally orthogonal to the pivotal axis of pivotal shaft 10. The buffer structure 54b consists of at least one buffer element. The “buffer element” refers to an element with elastic feature originating from the nature of the material or brought about by a specific structure. The buffer structure 54b is compressed between the sleeve 52 and rotating bracket 20 so as to apply an elastic force to the head 54h for pushing or retracting the same such that the head 54h can be urged against the surface 52f by an elastic force. The buffer elements constituting the buffer structure 54b may be in the form of slit-type disk resilient washers (see FIG. 1), disk resilient washers (not shown), arc-shaped resilient washers (not shown) or wave-shaped resilient washers (not shown). If more than two elastic elements are used, it is recommended that they be arranged in pairs in a way that the front side of one buffer element is opposed to the reverse side of the other. This helps to obtain a better buffering effect and a longer life. The buffer element can also be in the form of a single coil spring (not shown).

To assembly the modular pivotal hinge 1, the pivotal shaft 10 is inserted through the rotating bracket 20, elastic means 40 (preferably includes a liner therein) and sleeve 52 of buffering means 50, and then the axle 14 is non-rotatably inserted into and secured to the slot 34 of the base 30. Thereafter, mounting part 32 of the base 30 and the mounting part 22 of the rotating bracket 20 are respectively mounted onto the first and second members. The first and second members are then rotatable with respect to each other under the help of modular pivotal hinge 1.

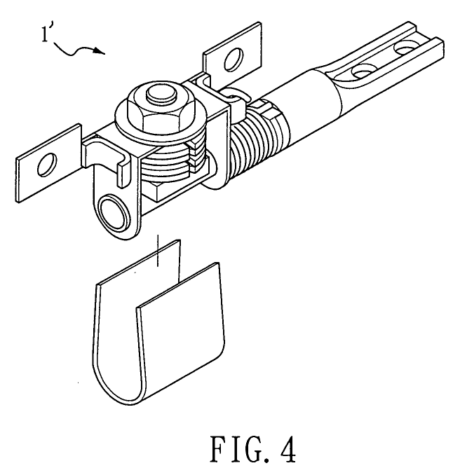

The present invention can, for example, be used with a laptop computer having an LCD display (second member) and a machine (first member) to allow them to pivot with each other. Before the laptop computer is operated, the LCD display (second member) and the machine (first member) are closed, and the elastic means 40 is in a torsion state. As a user opens the LCD display by pushing a release switch (not shown) or by other ways, the torsion energy in the elastic means 40 will urge the LCD display (second member) to swing away from the machine (first machine) such that the rotating bracket 20 is rotated about the pivotal axis. The rotation of the rotating bracket 20 causes the head 54h of the buffering means 50 to elastically bias against the axle 14 (in case the pivotal hinge does not use the sleeve 52; see the modular pivotal hinge 1′ of FIG. 4) or against the sleeve 52 formed with a through hole 52h (in case the sleeve 52 is present). In any of the above embodiments, the friction between the buffering means 50 and axle 14 (or sleeve 52) remains the same during rotation of the rotating bracket 20 because the axle 14 (or sleeve 52) has a constant curvature. According to a modified embodiment of the present invention, where the modular pivotal hinge uses a sleeve 52 which surface 52f shapes as a cam sidewall having varying curvature and the through hole 52h is non-rotatably coupled to the axle 14, the pivotal rotation of the rotating bracket 20 will urge the head 52h to move on the surface 52f. When the head 52h moves to a position of the surface 52f with an increased radius or curvature, the swinging action slows due to the increased friction and finally stops at a predetermined position. At this time, the user can still manually rotate the LCD display to a desired angular orientation for viewing.

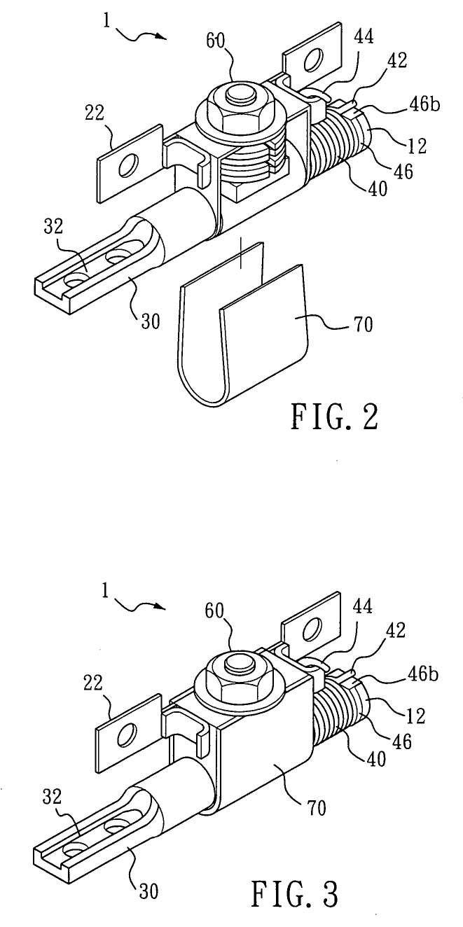

FIGS. 2 and 3 illustrate an assembled modular pivotal hinge 1 coupled to a tuning member 60 and/or an outer cap 70. As shown, the modular pivotal hinge 1 can be provided with a tuning member 60 which can adjust the buffer structure to a more tensioning state such that the buffer structure 54b will not put too much pressure on the surface 52f. The modular pivotal hinge 1 can also be provided with an outer cap 70 to protect the buffer structure 54 from dust.

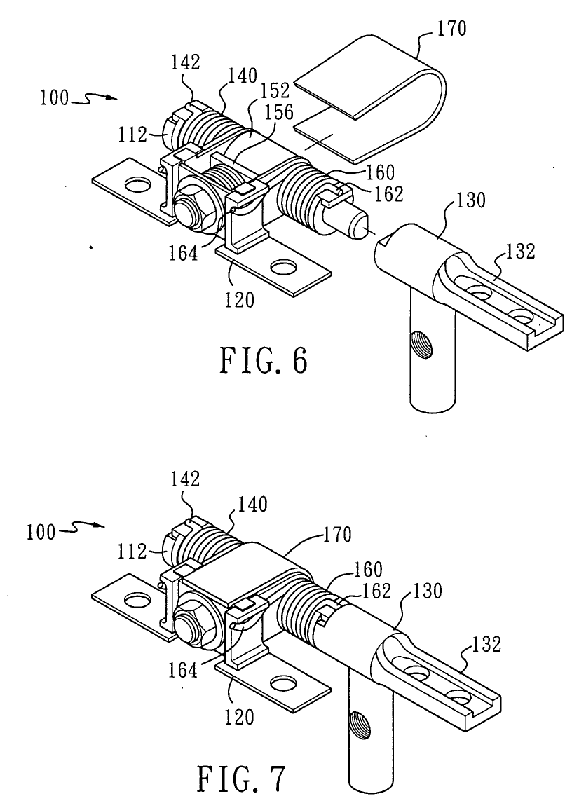

FIGS. 5 to 7 illustrate another embodiment of a modular pivotal hinge 100 according to the present invention. The modular pivotal hinge 100 comprises a pivotal hinge 110, a rotating bracket 120, a base 130, an elastic means 140, a buffering means 150, and a second elastic means 160.

Modular pivotal hinge 100 is constructed according to the theory of the modular pivotal hinge 1 of the first embodiment, with the exception that it incorporates a second elastic means 160 for the rotating bracket 120 and base 130 for improving the pivotal torsion of the system. The second elastic means 160 is preferably in the form of a coil spring having a first end 162 and a second end 164. The first end 162 is supported on a supporting surface 136 of the base 130. The second end 120 is supported on the retaining element 128 of the rotating bracket 120. A friction block 156 is clamped between a sleeve 152 and an elastic buffer structure 154 to provide both improved friction and shock absorption. The friction block 156 can be replaced by an oil-proof ring (not shown) for preventing leakage of oil slick.

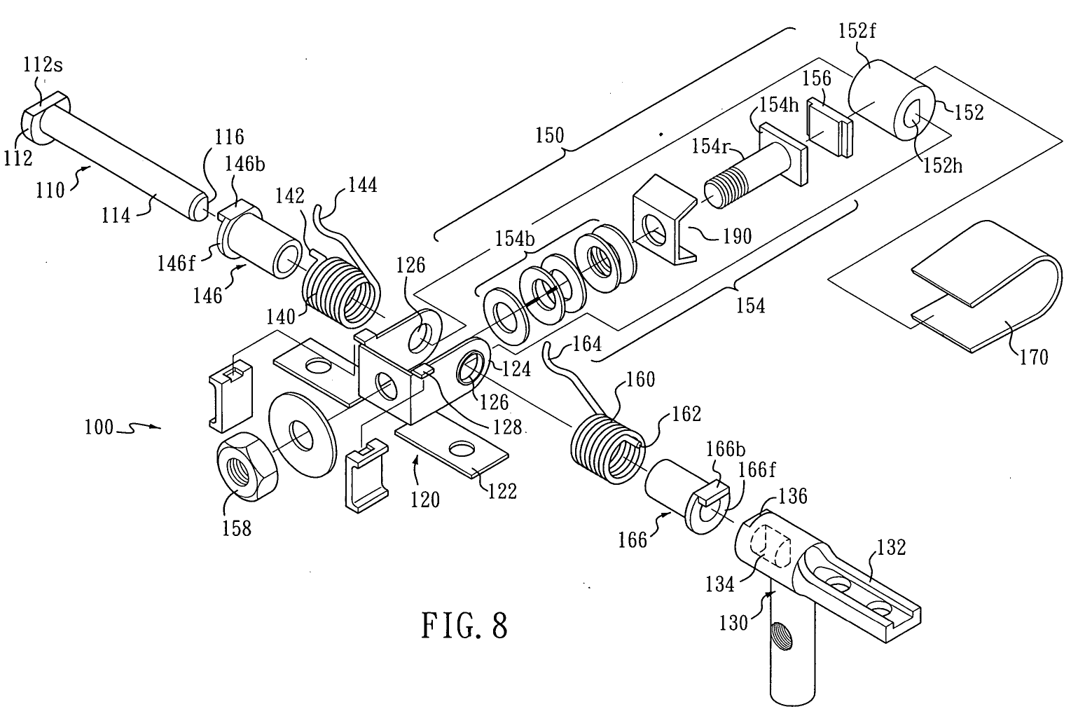

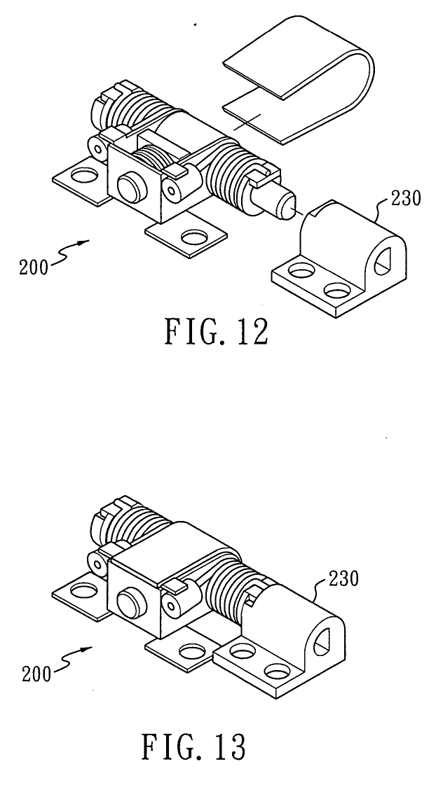

FIGS. 8 to 12 disclose a modified embodiment of the modular pivotal hinge 100 of FIGS. 5 to 7 with outer caps 170, 180 and/or elastic mask 190 intended for preventing dust and/or oil leakage, which will be explained in details as follows.

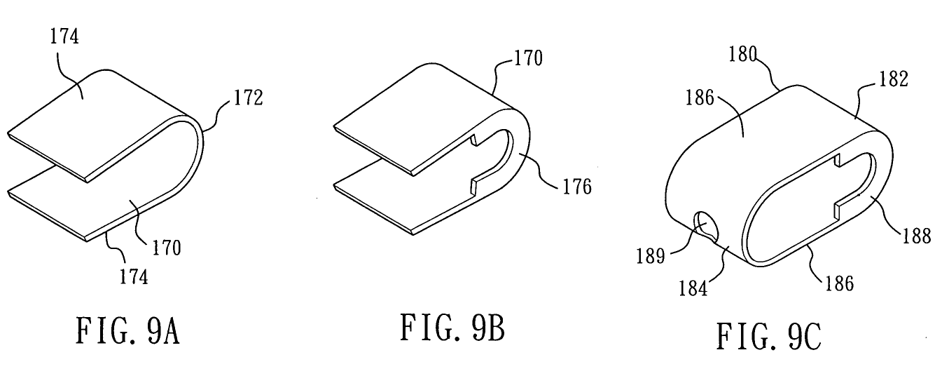

The outer cap 170 is preferably made of an elastic material such as steel, plastic, and rubber. FIG. 9A illustrates a simple outer cap 170 as shown in FIG. 8, which is in a U-shaped structure having a curved portion 172 and a pair of plates 174. Preferably, as shown in FIG. 9B, the outer cap 170 can comprise an opposite pair of curved shields 176 (only one of which is shown), each extending from a side of one plate 174, along the curved portion 172 and to the other plate 174. FIG. 9C illustrates a closed-type outer cap 180 having a pair of opposite curved portions 182, 184 and a pair of plates 186, wherein the curved portion 182 is provided with an opposite pair of curved shields 188 (only one of which is shown) while the other curved portion 184 is formed with a hole 189 to allow the post 154r to pass through. The outer cap 180 is preferably made of rubber.

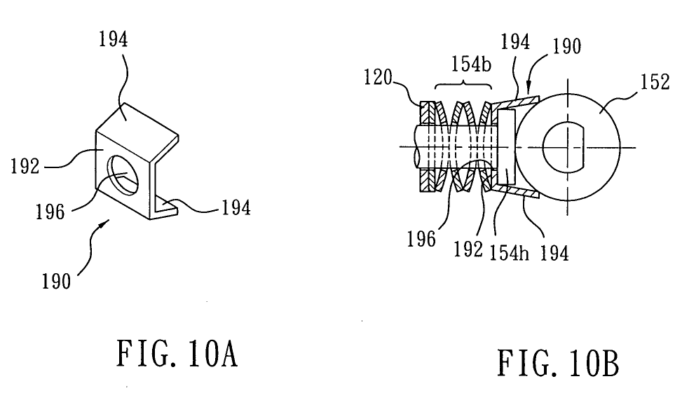

As shown in FIGS. 8, 10A, and 10B, the elastic mask 190 is generally in a U-shaped structure having a flat portion 192 and a pair of elastic wings 194 extending from the ends of the flat portion 192. The flat portion 192 is formed with a hole 196 to allow the post 154r to pass through. As preferably shown in FIG. 10B, the elastic mask 190 is disposed between the buffer structure 154b and the head 154h (or friction block 156 if present; see FIG. 8), with the elastic wings 194 thereof elastically clamping the surface 152f of the sleeve 152. In this manner, the elastic mask 190 provides a simple enclosing structure that encloses the head 154h between the elastic mask 190 and the surface 152f of the sleeve 152. This provides the benefit that, during the rotation of the modular pivotal hinge 100, the elasticity of the elastic wings 194 always keeps the same in elastic contact with the sleeve surface 152f despite of its varying curvature, and thus prevents the modular pivotal hinge 100 from dust and oil leakage. The elastic mask 190 is preferably made of steel which provides not only good elasticity but also wear resistance. The elastic mask 190 can further include liquid-absorbing material such as cotton to retain the lubricant oil.

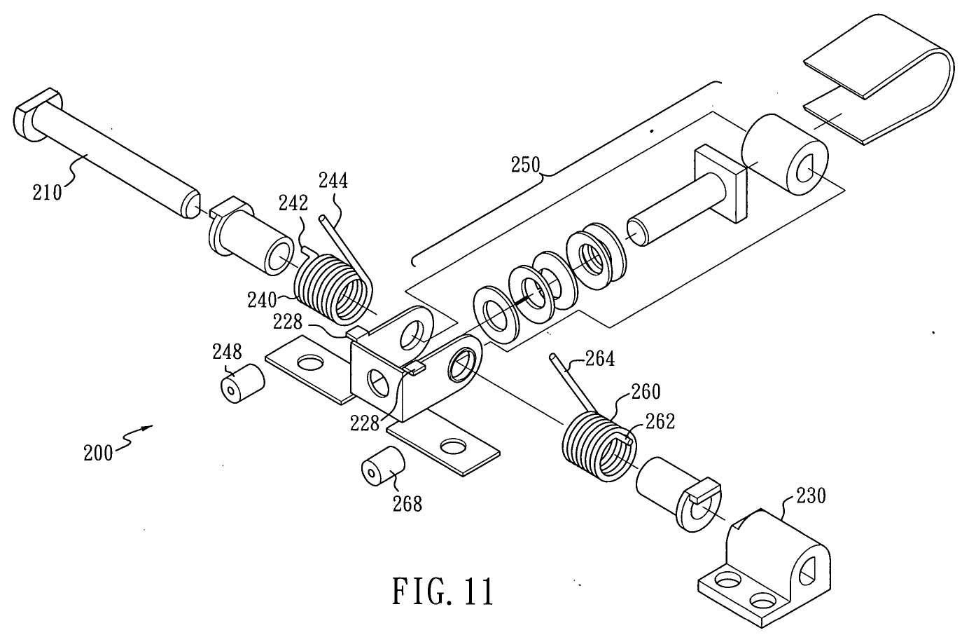

FIGS. 11 to 13 illustrate a further embodiment of a modular pivotal hinge 200 comprising a pivotal hinge 210, a rotating bracket 220, a base 230, an elastic means 240, a buffering means 250, and a second elastic means 260.

Modular pivotal hinge 200 is constructed according to the theories of the aforementioned embodiments, with the exception that the second ends 244, 266 of the elastic means 240 and second elastic means 260 are provided with fixation sleeves 248, 268 and coupled to a pair of retaining elements 228. If necessary, the leakage-proof elements 170, 180, and 190 as illustrated in FIGS. 8 to 12 may be used with the modular pivotal hinge 200.

As the invention has been particularly described with respect to preferred embodiments thereof, persons skilled in the art will understand that the above and other changes in form and detail may be made without departing from the scope and spirit of the invention. All of the above are used to illustrate the preferred embodiments of the present invention, and are not intended for limiting the present invention. Any equivalent embodiment of other simple variations made according to the structure, features, spirit and the claims of the present invention should all be included within the scope of the following claims.

What is claimed is:

1. A modular pivotal hinge for pivoting between a first member and a second member to allow the same to pivot with respect to each other, comprising:
a pivotal shaft comprising an axle extending along a pivotal axis and an inset;
a rotating bracket comprising a mounting part for fixation to the second member and a rotating part for coupling to the axle and allowing said rotating bracket to pivot around said axle;
a base comprising a mounting part for fixation to the first member and a slot extending to the inside thereof along an axis, the slot being constructed in a way to allow the axle to be inserted and secured therein;
an elastic means coupled to the axle for providing a spring force to urge the second member to pivot away from the first member; and
a buffering means coupled to the rotating bracket and elastically bias against the axle.

2. The modular pivotal hinge as set forth in claim 1, wherein the elastic means is a coil spring having a first end and a second end respectively supported on the base and the rotating bracket.

3. The modular pivotal hinge as set forth in claim 2, wherein a liner is arranged inside the coil spring-type elastic means.

4. The modular pivotal hinge as set forth in claim 2, wherein the pivotal shaft comprises a head having a supporting surface for supporting the first end of the elastic means.

5. The modular pivotal hinge as set forth in claim 2, further comprising a second coil spring, said second coil spring comprising a first end and a second end respectively supporting on the base and the rotating bracket.

6. The modular pivotal hinge as set forth in claim 5, wherein the base has a supporting surface for supporting the first end of the second coil spring.

7. The modular pivotal hinge as set forth in claim 1, wherein the buffering means comprises a head, a post, and a buffer structure, the buffer structure applying elastic/buffering force on the head such that the head can elastically bias against the axle.

8. The modular pivotal hinge as set forth in claim 7, further comprising a sleeve arranged on the axle in a way that it is clamped between the buffering means and the axle.

9. The modular pivotal hinge as set forth in claim 8, wherein the sleeve has a surface and a through hole, wherein the surface shapes as a cam sidewall having varying curvature and surrounding the rotary through hole, and the through hole is configured for non-rotatably coupled to the axle.

10. The modular pivotal hinge as set forth in claim 7, wherein the head provides friction at one of its faces facing the axle.

11. The modular pivotal hinge as set forth in claim 7, further comprising a sleeve arranged on the axle in a way that it is clamped between the buffering means and the axle, and an oil-proof ring between the head and sleeve for preventing leakage of oil slick.

12. The modular pivotal hinge as set forth in claim 7, wherein the buffer structure consists of at least one buffer element, the buffer element being a coil spring or selected from the group consisting of slit-type disk resilient washers, disk resilient washers, arc-shaped resilient washers, and wave-shaped resilient washers.

13. The modular pivotal hinge as set forth in claim 12, wherein the group comprises more than two resilient washers which are arranged in pairs with the front side of one resilient washer of each pair being opposed to the reverse side of the other of said pair.

14. The modular pivotal hinge as set forth in claim 7, wherein a friction block is clamped between the buffer structure and the axle.

15. The modular pivotal hinge as set forth in claim 13, wherein a friction block is clamped between the buffer structure and the axle.

16. The modular pivotal hinge as set forth in claim 8, wherein a friction block is clamped between the buffer structure and the sleeve.

17. The modular pivotal hinge as set forth in claim 1, wherein the rotating bracket is in a U-shape.

18. The modular pivotal hinge as set forth in claim 1, further comprising an outer cap.

19. The modular pivotal hinge as set forth in claim 18, wherein the outer cap is in a U-shaped structure having a curved portion and a pair of plates.

20. The modular pivotal hinge as set forth in claim 19, wherein the outer cap comprises an opposite pair of curved shields each of which extends along the curved portion.

21. The modular pivotal hinge as set forth in claim 18, wherein the outer cap is a closed-type outer cap having a pair of opposite curved portions and a pair of plates, wherein curved portion is provided with an opposite pair of curved shields while the other curved portion is formed with a hole.

22. The modular pivotal hinge as set forth in claim 21, wherein one of the curved portions is provided with an opposite pair of curved shields while the other is formed with a hole.

23. The modular pivotal hinge as set forth in claim 7, further comprising a tuning member coupled to the post for adjusting the buffer structure to a desired tensioning.

24. The modular pivotal hinge as set forth in claim 1, wherein the rotating part is formed with holes for coupling the rotating bracket to the axle and allowing said rotating bracket to pivot around said axle, and wherein the rotating part is provided with flanges which extend a thickness from each of the holes for broadening the contact area of the rotating part with the pivotal shaft.

25. The modular pivotal hinge as set forth in claim 7, further comprising an elastic mask disposed between the buffer structure and the head, wherein the elastic mask is in a generally U-shaped structure having a flat portion and a pair of elastic wings extending from the ends of the flat portion.

26. An elastic mask for use with a modular pivotal hinge as set forth in claim 9, said elastic mask being adaptable to elastically clamp a sleeve surface having a varying curvature so as to prevent dust and/or oil leakage, characterized in that said elastic mask is generally in a U-shaped structure having a flat portion and a pair of elastic wings extending from the ends of the flat portion, such that during the rotation of the modular pivotal hinge, the elasticity of the elastic wings always keeps the same in elastic contact with the sleeve surface despite of its varying curvature.
